(19) United States
(12) Patent Application Publication
(10) Pub. No.: US 2019/0200266 A1
(43) Pub. Date: Jun. 27, 2019

(54) ACCESS NETWORK SWITCHING METHOD IN HETEROGENEOUS RADIO ACCESS NETWORK AND USER EQUIPMENT PERFORMING THE SAME

(71) Applicant: ELECTRONICS AND TELECOMMUNICATIONS RESEARC INSTITUTE, Daejeon (KR)

(72) Inventors: Sun Mi JUN, Daejeon (KR); No Ik PARK, Daejeon (KR)

(21) Appl. No.: 16/196,566

(22) Filed: Nov. 20, 2018

(30) Foreign Application Priority Data
Dec. 22, 2017 (KR) 10-2017-0178621

(51) Int. Cl. H04W 36/12; H04W 36/00

(52) U.S. Cl. CPC H04W 36/125; H04W 36/0027; H04W 36/0022

(57) ABSTRACT

An access network switching method in a heterogeneous radio access network and user equipment performing the same. The UE selects access network switching of first data from a user while receiving the first data from a first access network, and selects a second access network corresponding to the access network switching from the user. The UE performs access network switching to the second access network and receives the first data from the second access network.

### CROSS-REFERENCE TO RELATED APPLICATION

This application claims priority to and the benefit of Korean Patent Application No. 10-2017-0178621 filed in the Korean Intellectual Property Office on Dec. 22, 2017, the entire content of which is incorporated herein by reference.

### BACKGROUND OF THE INVENTION

### 1. Field of the Invention

The present invention relates to an access network switching method in a heterogeneous radio access network, and a user equipment performing the same.

### 2. Description of Related Art

Various wireless environments such as 4G LTE based on 3GPP and WiFi based on 802.11 coexist in the current mobile wireless network environment. In the coming 5G networks, there is a growing demand for optimal service in a situation where various wireless environments coexist.

In particular, when a user wants to transmit and receive traffic by simultaneously accessing different radio access networks, technologies that can select an access network that matches the traffic attributes and transmit the traffic are needed. Traffic mobility technology can help users to provide more cost-effective data transmission services and support an increase of transmission capacity that users can utilize.

In order to support traffic movement in a heterogeneous wireless access network in which LTE and WiFi exist, there is a data offloading technology using an access network discovery and selection function (ANDSF) in 4G mobile communication.

### SUMMARY OF THE INVENTION

The present invention has been made in an effort to provide a method for a user to arbitrarily select an access network and to switch access traffic between selected networks.

According to an exemplary embodiment of the present invention, a method for user equipment (UE) to switch an access network in a heterogeneous access network is provided. The method may include receiving first data from a first network of multiple access networks, selecting access network switching of the first data from a user, selecting a second access network corresponding to the access network switching from the user, performing access network switching to the second access network, and receiving the first data from the second access network.

The performing may include determining whether the second access network is an access network that the UE is currently connected to.

The performing may further include transmitting a protocol data unit (PDU) session modification request message to an Access and Mobility Management Function (AMF) when the second access network is an access network to which the UE is currently connected in the determining.

The PDU session modification request message may include information on traffic of the first data and path information on the second access network.

The performing may further include receiving a PDU session modification response message from the AMF, and the PDU session modification response message may include an ACK for the PDU session modification request message.

The performing may further include establishing access to the second access network and transmitting a protocol data unit (PDU) session establishment request message to an Access and Mobility Management Function (AMF) when the second access network is not an access network to which the UE is currently connected in the determining.

The PDU session establishment request message may include a PDU session identifier that has been registered through the first access network, and a request type of the PDU session establishment request message may include an existing PDU session or a multi-access PDU session and an added radio access technology type.

The performing may further include receiving a PDU session establishment response message from the AMF, and the PDU session establishment response message may include an ACK for the PDU session establishment request message.

A unit of the first data may be a data network, a tunnel for a data bearer, a service grouping a plurality of internet protocol (IP) flows, a QoS flow identity, or a single IP flow.

According to another exemplary embodiment of the present invention, a method for switching a first access network, which is a current access network of first data, to a second access network in a heterogeneous access network is provided. The method may include receiving, by user equipment (UE), the first data and the second access network from a user, determining, by the UE, whether the second access network is an access network to which the UE is currently connected, and requesting, by the UE, Access and Mobility Management Function (AMF) to switch an access network to the second access network.

The requesting may include transmitting a protocol data unit (PDU) session modification request message to the AMF when the second access network is an access network to which the UE is currently connected, and the method may further include confirming, by the AMF, a Session Management Function (SMF) corresponding to the PDU session modification request message, and transmitting, by the AMF, the PDU session modification request message to the SMF.

The PDU session modification request message may include information on an IP flow mobility (IFOM) rule update, and the method may further include transmitting, by the SMF, a PDU session modification response message to the AMF after the SMF updates the IFOM rule.

The method may further include updating, by the UE, the IFOM rule after the UE receives the PDU session modification response message from the AMF.

The requesting may include transmitting a protocol data unit (PDU) session establishment request message to the AMF when the second access network is not an access network to which the UE is currently connected, and the method may further include selecting, by the AMF, a Session Management Function (SMF) corresponding to the PDU session establishment request message, and transmitting, by the AMF, the PDU session establishment request message to the SMF.

The PDU session establishment request message may include information on an IP flow mobility (IFOM) rule update, and the method may further include transmitting, by the SMF, a control message for path change to a User Plane Function (UPF) after the SMF updates the IFOM rule.

The method may further include transmitting, by the UPF, a response message to the control message to the SMF, and the response message may include ACK information for the updated IFOM rule.

A unit of the first data may be a data network, a tunnel for a data bearer, a service grouping a plurality of internet protocol (IP) flows, a QoS flow identity, or a single IP flow.

According to another exemplary embodiment of the present invention, user equipment (UE) performing access network switching in a multiple access network is provided. The UE may include a radio frequency (RF) module receiving a first data flow from a first access network of the multiple access networks, and a processor receiving access network switching of the first data flow from a user and selecting a second access network corresponding to the access network switching from the user, wherein the processor may determine whether the second access network is a network to which the UE is currently connected, and controls to request an Access and Mobility Management Function (AMF) to switch an access network to the second access network.

The processor may control to transmit a protocol data unit (PDU) session modification request message to the AMF when the second access network is an access network to which the UE is currently connected, and the PDU session modification request message may include information on an IP flow mobility (IFOM) rule update.

The processor may control to transmit a protocol data unit (PDU) session establishment request message to the AMF when the second access network is not an access network to which the UE is currently connected, and the PDU session establishment request message may include information on an IP flow mobility (IFOM) rule update.

According to an exemplary embodiment of the present invention, an optimal wired/wireless environment can be provided by selecting a data flow and an access network to be switched from a user.

According to an exemplary embodiment of the present invention, an access network can be switched on a granular data flow basis.

### BRIEF DESCRIPTION OF THE DRAWINGS

FIG. 1 is a diagram illustrating a service network of a 5G wireless communication system according to an exemplary embodiment of the present invention.

FIG. 2 is a diagram showing an example of access traffic switching according to an exemplary embodiment of the present invention.

FIG. 3 is a diagram illustrating an initial PDU session establishment method according to an exemplary embodiment of the present invention.

FIG. 4 is a diagram illustrating a PDU session addition establishment method according to an exemplary embodiment of the present invention.

FIG. 5 is a diagram illustrating a connection of a multi-access network according to an exemplary embodiment of the present invention.

FIG. 6 is a flowchart illustrating an access traffic switching method according to an exemplary embodiment of the present invention.

FIG. 7 is a diagram illustrating a GUI (Graphical User interface) of the UE according to an exemplary embodiment of the present invention.

FIG. 8 is a diagram illustrating a method for switching an access in a state where a multiple access network is connected according to an exemplary embodiment of the present invention.

FIG. 9 is a diagram illustrating a method for switching access in a state where a multiple access network is not connected according to an exemplary embodiment of the present invention.

FIG. 10 is a block diagram illustrating UE according to an exemplary embodiment of the present invention.

FIG. 11 is a diagram illustrating state transition of UE 100 according to the embodiment of the present invention.

FIG. 12 is a flowchart illustrating an access traffic switching method according to a state of a target RAT according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the present specification, user equipment (UE) may indicate a terminal, a mobile terminal (MT), a mobile station (MS), an advanced mobile station (AMS), a high reliability mobile station (HR-MS), a subscriber station (SS), a portable subscriber station (PSS), an access terminal (AT), or the like, and may include all or some of the functions of the terminal, the MT, the AMS, the HR-MS, the SS, the PSS, the AT, or the like.

In addition, a base station (BS) may indicate an advanced base station (ABS), a high reliability base station (HR-BS), a nodeB, an evolved nodeB (eNodeB), a base transceiver station (BTS), a mobile multihop relay (MMR)-BS, a relay station (RS) serving as a base station, a high reliability relay station (HR-RS) serving as a base station, and the like, and may include all or some of the functions of the base station, the ABS, the nodeB, the eNodeB, the BTS, the MMR-BS, the RS, the HR-RS, and the like.

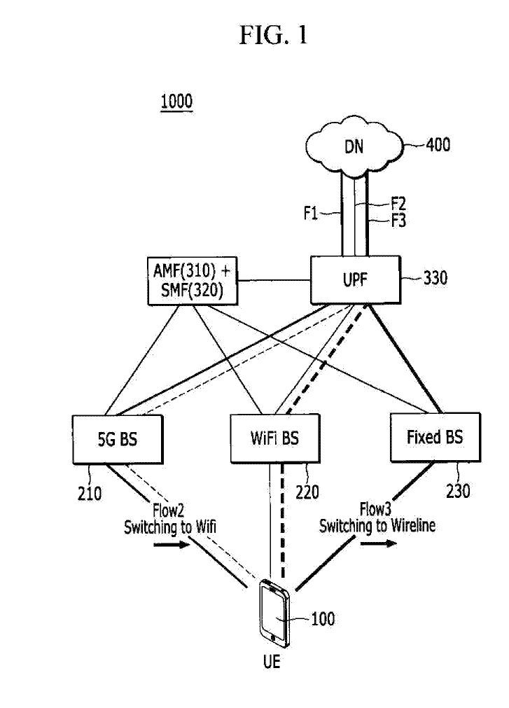

FIG. 1 is a diagram illustrating a service network of a 5G wireless communication system according to an exemplary embodiment of the present invention.

As shown in FIG. 1, in the service network of the 5G wireless communication system, a 5G New Radio Access Technology (RAT) based cellular mobile access network, a wireless LAN access network, and a wired network are mixed. The cellular mobile access network, the wireless LAN access network, and the wired network are integrated with each other. Meanwhile, in FIG. 1, a point where UE accesses a cellular mobile access network based on 5G New RAT is indicated by 5G BS (5G Base Station), a point where UE accesses a wireless LAN access network is indicated by WiFi BS (WiFi Base Station), and a point where UE accesses the wired network is indicated as Fixed BS (Fixed Base Station). The WiFi BS may have N3IWF (Non-3GPP InterWorking Function) in a 5G system.

A 5G wireless communication system 1000 according to an exemplary embodiment of the present invention includes UE 100, a 5G BS 210, a WiFi BS 220, a Fixed BS 230, an access and mobility management Function (AMF) 310, a session management function (SMF) 320, a user plane function (UPF) 330, and a data network (DN) 400.

The AMF 310 performs an authentication and access procedure of the UE 100. The SMF 320 performs signaling procedures for configuring/changing/releasing a protocol data unit (PDU) session, traffic path setting, and traffic mobility management. The UPF 330 connects a data plane between at least one access network and the DN 400, whereby traffic of the UE 100 (i.e., user) can be transmitted and received. As shown in FIG. 1, in a situation where heterogeneous wired and wireless access networks are mixed, the UPF 330 can be connected to base stations 210, 220, and 230 of different access networks, respectively. Meanwhile, the AMF 310 and the SMF 320 may be physically independent of each other or may be integrated with each other. A more detailed description of the AMF 310, the SMF 320, and the UPF 330 will be readily apparent to those skilled in the art and is described in 3GPP (3rd Generation Partnership Project) TS (Technical Specification) 23.502 and is therefore omitted.

In general, access traffic movement methods are classified into access traffic steering, access traffic switching, and access traffic splitting. Access traffic steering is a method in which the best access network is selected and transmitted for new data flows that have not yet initiated. Access traffic switching is a method in which service continuity is maintained and transferred to a new access network for a data flow that has already initiated between the data network and the UE and the traffic is being transmitted. Access traffic splitting is a method in which one data flow traffic set is distributed across multiple access networks. An access traffic movement method according to an exemplary embodiment of the present invention relates to access traffic switching among the above three methods.

FIG. 1 illustrates a concept of access traffic switching in the service network of the 5G wireless communication system according to an exemplary embodiment of the present invention. In FIG. 1, it is assumed that the DN 400 and the UE 100 maintain a service with a connection to a first data flow F1, a second data flow F2, and a third data flow F3. It is also assumed that before access traffic switching is performed, the first data flow F1 and the second data flow F2 are connected to a cellular mobile access network based on 5G New Radio Access Technology (RAT) to receive a service, and the third data flow F3 is connected to a wireless LAN access network to receive a service. At this time, in a state in which the service continuity for the second data flow F2 is maintained, access traffic switching can be performed from the 5G New RAT based cellular mobile access network to the wireless LAN access network. In a state in which the service continuity for the third data flow F3 is maintained, access traffic switching can be performed from the wireless LAN access network to the wired network.

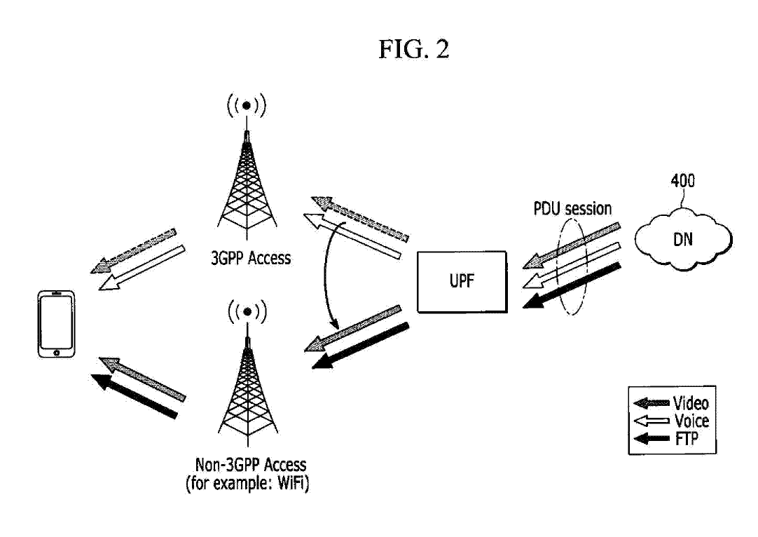

FIG. 2 is a diagram showing an example of access traffic switching according to an exemplary embodiment of the present invention. As shown in FIG. 2, the access network for the video data flow may be switched from a 3GPP access (e.g., 5G New RAT) to a Non-3GPP access (e.g., WiFi).

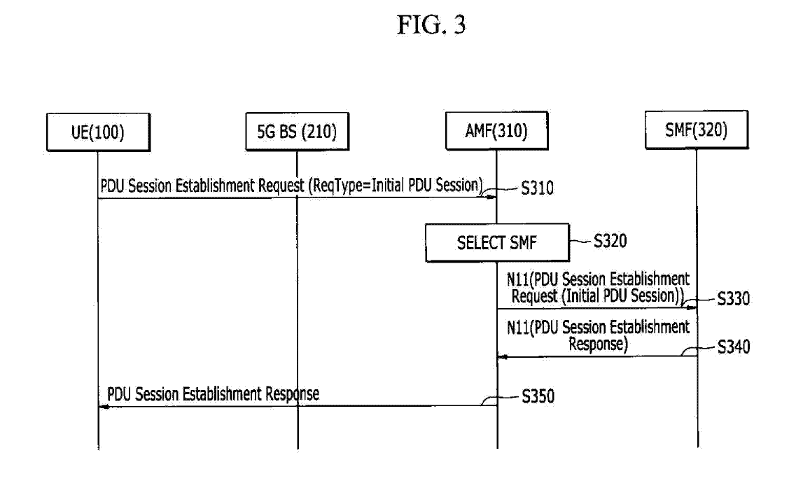

FIG. 3 is a diagram illustrating an initial PDU session establishment method according to an exemplary embodiment of the present invention.

First, the UE 100 transmits a PDU Session Establishment Request message to the AMF 310 through the 5G BS 210 (S310). Here, a request type of the PDU Session Establishment Request is set to Initial PDU Session.

The AMF 310 selects the SMF 320 to establish an initial PDU session (S320), and transmits a PDU Session Establishment Request message to the selected SMF 320 through N11 (S330). Here, N11 is a reference point between the AMF and the SMF.

When receiving the PDU Session Establishment Request message in step S330, the SMF 320 performs session establishment and transmits a PDU Session Establishment Response message to the AMF 310 through N11 (S340).

Then, the AMF 310 transmits a PDU Session Establishment Request Response message to the UE 100 through the 5G BS 210 (S350).

Through this method of FIG. 3, one PDU session is established in the 5G network.

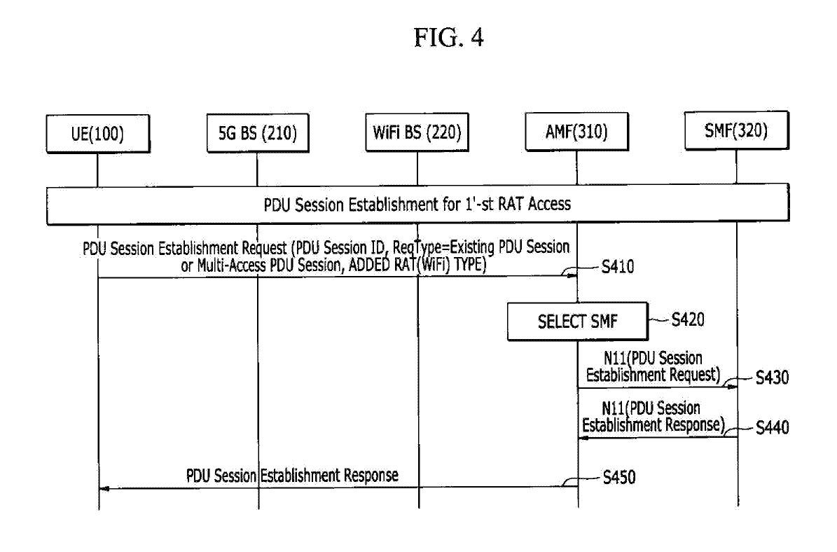

FIG. 4 is a diagram illustrating a PDU session addition establishment method according to an exemplary embodiment of the present invention.

First, it is assumed that one PDU session is established in the 5G network through the method shown in FIG. 3. With one PDU session established, a new RAT can be added through the following procedure.

The UE 100 transmits a PDU Session Establishment Request message to the AMF 310 through the WiFi BS 220 to add a new RAT (S410). Here, the PDU Session Establishment Request message includes a PDU session identifier (PDU session ID) registered through the Existing RAT, and a request type of the PDU Session Establishment Request message. The request type of the PDU Session Establishment Request message includes the Existing PDU Session or a Multi-Access PDU Session, and an added RAT type (e.g., WiFi, Wireless LAN). That is, it is specified that the PDU Session Establishment Request is not a new PDU Session Establishment Request and is not hand-over of the existing PDU session between different access networks (for example, between 3GPP and non-3GPP).

The AMF 310 selects the SMF 320 to establish a Multi-Access PDU session (S420), and transmits a PDU Session Establishment Request to the selected SMF 320 through N11 (S430). Here, in selecting the SMF 320, the AMF 310 selects the SMF (i.e., the SMF selected in step S320) that was selected when the initial PDU session is established in FIG. 3. That is, the AMF 310 selects the same SMF as the SMF in which the existing PDU session is established.

When receiving the PDU Session Establishment Request message in step S330, the SMF 320 performs session addition and transmits a PDU Session Establishment Response message to the AMF 310 through N11 (S440).

Then, the AMF 310 transmits a PDU Session Establishment Response message to the UE 100 through the WiFi BS 220 (S450).

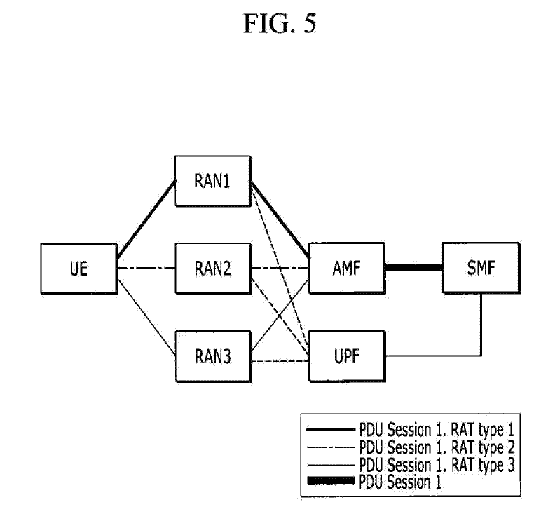

Through the method of FIG. 4, a new access network can be added to the already established existing PDU session. That is, a multi-access network can be concurrently connected to one PDU session. FIG. 5 is a diagram illustrating a connection of a multi-access network according to an exemplary embodiment of the present invention. As shown in FIG. 5, one UE can perform a single or simultaneous access to multiple access networks, and a single PDU session allows routing to multiple access networks.

The 5G traffic model according to the exemplary embodiment of the present invention has the following features. First, one PDU session may be routed to a multiple access network. Second, UE (terminal) can have a plurality of physical interfaces, and can have one logical interface for multiple physical interfaces. Accordingly, one IP address can be shared among multiple physical interfaces. Third, the UE 100 and the UPF 330 may share the same Inter-RAT routing policy information. Finally, access traffic steering and access traffic switching can be supported.

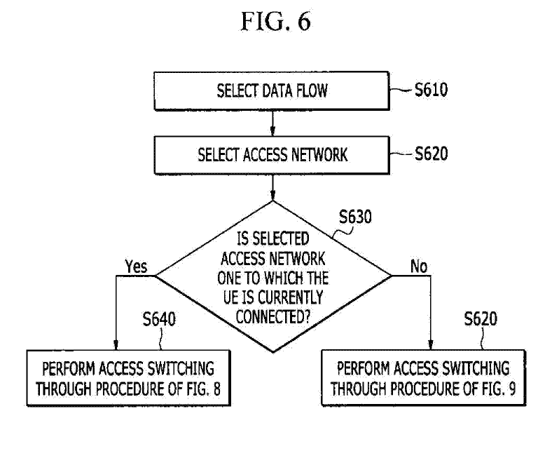

Hereinafter, access traffic switching according to an exemplary embodiment of the present invention will be described. The access traffic switching method according to an exemplary embodiment of the present invention is that the user terminal (UE) requests data access switching, which will be described in detail with reference to FIG. 6 to FIG. 9. In the following description, data refers to an IP data flow, but may be referred to as traffic in terms of the user's service. Meanwhile, the data switching an access network is a DN (Data Network), a tunnel for a data bearer, a service unit grouping a plurality of IP flows (i.e., an application program unit, a QoS Flow Identity (i.e., a group of data flows sharing a common QoS)), or a single IP flow.

In FIG. 6 to FIG. 9, access traffic switching to be switched from a wireless LAN access network (WiFi) to a 5G New RAT based cellular mobile access network (hereinafter referred to as a 5G network) will be described, but access traffic switching between other access networks may also be applied.

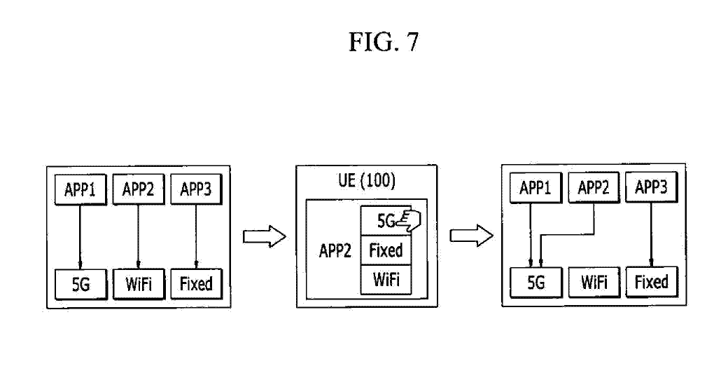

FIG. 6 is a flowchart illustrating an access traffic switching method according to an exemplary embodiment of the present invention, and FIG. 7 is a diagram illustrating a GUI (Graphical User Interface) of the UE 100 according to an exemplary embodiment of the present invention.

First, the user selects a data flow for switching an access network through the UE 100 (S610). Referring to FIG. 7, the UE 100 includes an application program 1 (APP1), an application program 2 (APP2), and an application program 3 (APP3), which are different application programs. Application program 1 (APP1) transmits/receives traffic through a 5G interface, application program 2 (APP2) transmits/receives traffic through a WiFi interface, and application program 3 (APP3) transmits/receives traffic through a fixed interface. As shown in FIG. 7, the user switches an access network of the application program 2 (APP2) currently being serviced through the GUI of UE 100. That is, the user selects application program 2 (APP2) of the UE 100 and selects a data flow for access network switching.

The user selects an access network to be switched for the data flow selected in S610 (S620). Referring to FIG. 7, the application program 2 (APP2) receives a service through a WiFi interface, and the user can attempt to switch to 5G access through the UE 100.

The UE 100 determines whether the access network selected in step S620 is an access network to which the UE 100 is currently connected (S630). That is, the UE 100 determines whether the access network to which the user wants to switch is already connected to the multiple access network through a multi-access PDU session.

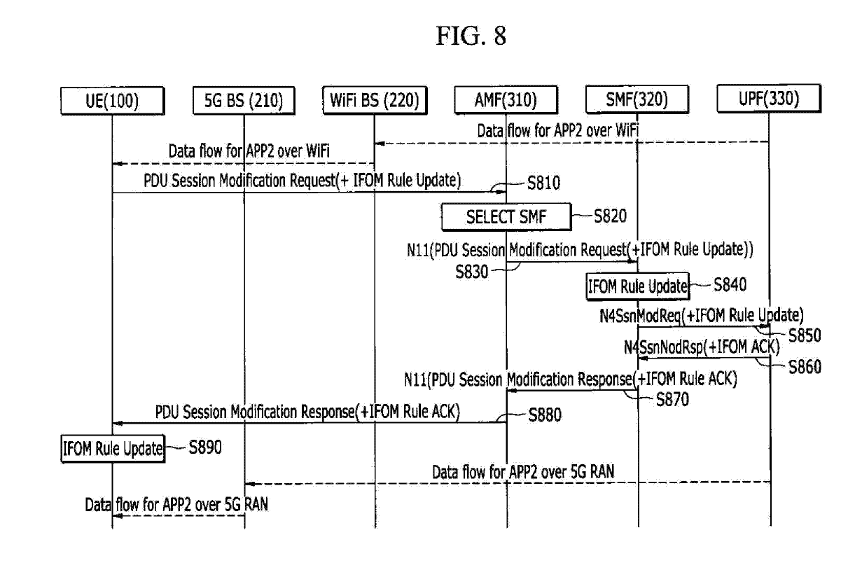

If it is determined in step S630 that the multiple access network is connected, the UE 100 performs access switching through a procedure of FIG. 8 described below (S640). The UE 100 performs control message transmission requesting access network switching to a network. Here, the UE 100 can transmit a control message using a NAS (Non-Access Stratum) interface of the 5G system. Then, the UE 100 receives a response message from the network, and at the same time, the network and the UE 100 perform a transmission path change for switching the access network for the corresponding data flow.

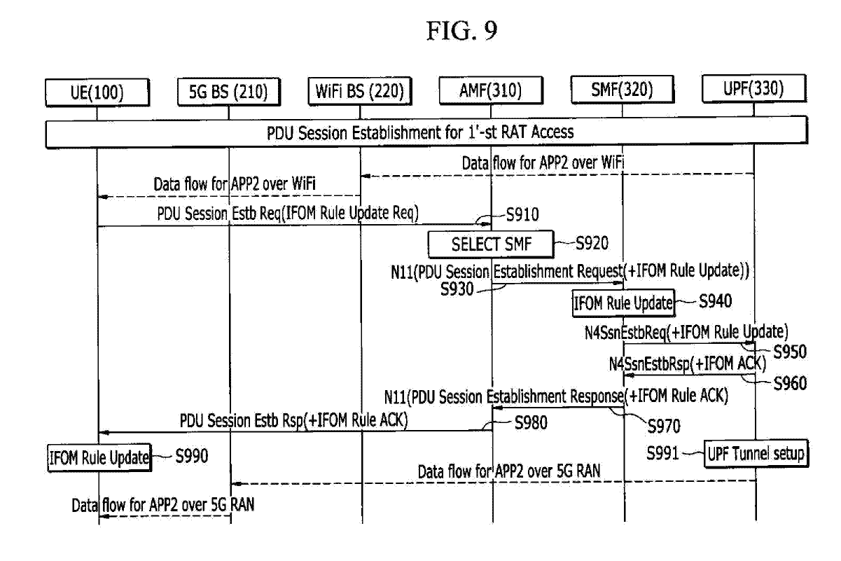

If it is determined in step S630 that the multiple access network is not connected, the UE 100 performs access switching through a procedure of FIG. 9 described below (S640). Here, the UE 100 according to an embodiment of the present invention performs a multi-access PDU session establishment procedure and simultaneously transmits a control message requesting access network switching.

Referring to FIG. 7, the UE 100 according to an embodiment of the present invention transmits a control message for changing an access network for data flows included in the APP2 to a network. Through the method of FIG. 6, an access network of the APP2 is changed from WiFi to 5G, and the service can be continued.

FIG. 8 is a diagram illustrating a method for switching access in a state where a multiple access network is connected according to an exemplary embodiment of the present invention.

First, it is assumed that a multi-access network is concurrently connected through a single session through the method as shown in FIG. 4, and a data flow for APP2 is formed over a WiFi radio access network.

The UE 100 transmits a PDU Session Modification Request message to the AMF 310 through the WiFi BS 220 (S10). Here, the PDU Session Modification Request message is used when requesting a modification of the corresponding PDU session as one of NAS messages. The PDU Session Modification Request message includes access traffic information (for example, IP flow) to be switched and path information for a target access to be switched from a source access.

Here, access traffic represents data for switching an access network. The unit of access traffic is a DN (Data Network), a tunnel for a data bearer, a service unit grouping a plurality of IP flows (i.e., an application program unit, a QoS Flow Identity (i.e., a group of data flows sharing a common QoS)), or a single IP flow.

Meanwhile, the PDU Session Modification Request message according to an exemplary embodiment of the present invention includes information on an IP Flow Mobility (IFOM) rule update. A data unit of access traffic to which the access is to be switched is an IP flow, and when it is desired to change a path from a source access to a target access, the network and the U E exchange information about the IFOM rule update. The IFOM rule includes information on the data flow to be switched and path information for changing to a new access network. The data flow information includes a source address (IP address, Port), a destination address (IP address, Port), and a protocol type. The path information may include a target access network path or a preferred RAT interface (3GPP or non3GPP).

The AMF 310 receives the PDU Session Modification Request message, selects SMF 320 (S20), and transmits the PDU Session Modification Request message to the selected SMF 320 through N11 (S830).

The SMF 320 processes the received PDU Session Modification Request message and changes (updates) the IFOM rule (S840). Then, the SMF 320 transmits a control message for path (route) change to the UPF 330 through an N4 interface (S850). N4 is a reference point between SMF and UPF. Here, the control message for path change may be N4 Session Modification Request (N4SsnModReq). N4SsnModReq includes the modified IFOM rules.

The UPF 330 transmits a response message in response to the control message for path change received in step S850 (S860). Here, the response message may be N4 Session Modification Response (N4SsnModRsp). The N4SsnModRsp includes ACK information for the modified IFOM rule.

When the SMF 320 receives the response message in step S860, the SMF 320 transmits a PDU Session Modification Response message to the AMF 310 through N11 (S870). The PDU Session Modification Response message includes ACK information for the modified IFOM rule.

The AMF 310 transmits the PDU Session Modification Response message received in step S870 to the UE 100 through the WiFi BS 220 (S880).

When receiving the PDU Session Modification Response message, the UE 100 finally changes the IFOM rule (S890).

The access network of the data flow selected by the user is changed through the above procedure. For example, the access network for APP2 is changed from a WiFi access network to a 5G network.

The access switching method according to an exemplary embodiment of the present invention described in FIGS. 6 and 8 can switch an access network by applying a path changing rule for switching an access network of the data flow through the session changing procedure.

FIG. 9 is a diagram illustrating a method for switching access in a state where a multiple access network is not connected according to an exemplary embodiment of the present invention.

First, it is assumed that the multi-access network described in FIG. 4 is not formed and the application program 2 (APP2) has a data flow through a WiFi radio access network. That is, it is assumed that the data flow being serviced is switched to a target access network where the UE is not yet registered or a PDU session is not yet established.

The UE 100 transmits a PDU Session Establishment Request message to the AMF 310 through the 5G BS 210 as a target base station (S910). If the UE 100 is not registered to the target base station (5G BS 210) or does not have access to the AMF 310, a registration to the target base station and the AMF via target access are required prior to the PDU Session Establishment request.

Here, the PDU Session Establishment Request message is one of the NAS messages and can be used when adding a new RAT. Therefore, as described in FIG. 4, the PDU Session Establishment Request message includes a PDU session identifier (PDU session ID) registered through the Existing RAT, and a request type of the PDU Session Establishment Request message. The request type of the PDU Session Establishment Request message includes the Existing PDU session or a Multi-Access PDU session, and an added RAT type (e.g., 5G). Meanwhile, the PDU Session Establishment Request message according to the embodiment of the present invention includes information about an IFOM (IP Flow Mobility) update request. The information about the IFOM update request includes data flow information, and path information for switching to a target (or new) access. The data flow information includes a source address (IP address, Port), a destination address (IP address, Port), and a protocol type.

The AMF 310 receives the PDU Session Establishment Request message, selects SMF 320 (S920), and transmits the PDU Session Establishment Request message to the selected SMF 320 through N11 (3930).

The SMF 320 processes the received PDU Session Establishment Request message and changes (updates) the IFOM rule (3940). Then, the SMF 320 transmits a control message for path establishment to the UPF 330 through the N4 interface (S950). Here, the control message for path establishment may be N4 Session Establishment Request (N4SsnEstbReq). N4SsnEstbReq includes the modified IFOM rules.

The UPF 330 transmits a response message in response to the control message for path establishment received in step 3950 (S960). Here, the response message may be N4 Session Establishment Response (N4SsnEstbRsp). The N4SsnEstbRsp includes ACK information for the modified IFOM rule.

When the SMF 320 receives the response message in step 3960, the SMF 320 transmits a PDU Session Establishment Response message to the AMF 310 through N11 (S970). The PDU Session Establishment Response message includes the modified IFOM rules or the ACK information of the modified IFOM rules.

When receiving the PDU Session Establishment Response message from the SMF 320, the AMF 310 transmits a response message for path establishment to the UE 100 through N1 (S980). N1 is a reference point between UE and AMF. Here, the response message for path establishment may be a PDU Session Establishment Response message. The PDU Session Establishment Response message includes the modified IFOM rules or the ACK information of the modified IFOM rules.

When receiving the PDU Session Establishment Response message, the UE 100 finally changes (updates) the IFOM rule (S990). At this time, the UPF 330 sets up a UPF tunnel (S991). This adds a new access network (for example, 5G RAN) and changes data flow to a new access network (for example, 5G RAN).

The access switching method according to an exemplary embodiment of the present invention described in FIG. 6 and FIG. 9 may add a new access network and perform a path change of data flow to the new access network through the session establishment procedure.

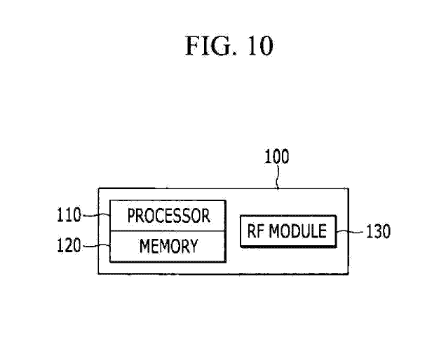

FIG. 10 is a block diagram illustrating UE 100 according to an exemplary embodiment of the present invention.

As shown in FIG. 10, the UE 100 according to an exemplary embodiment of the present invention includes a processor 110, a memory 120, and a radio frequency (RF) module 130.

The processor 110 may be configured to implement the methods and functions described in FIG. 1 to FIG. 9.

The memory 120 is coupled to the processor 110 and stores various information related to the operation of the processor 110.

The RF module 130 is coupled to an antenna and transmits or receives radio signals. The antenna may be implemented as a single antenna or a multiple antenna (MIMO antenna).

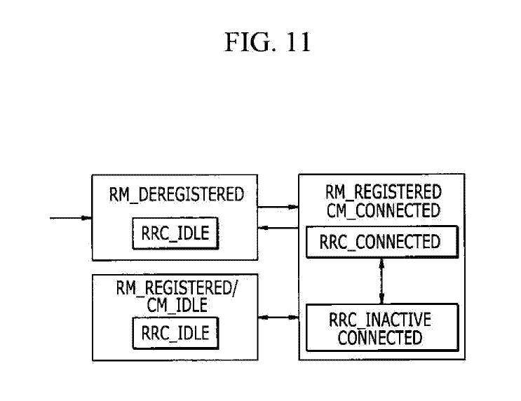

FIG. 11 is a diagram illustrating state transition of UE 100 according to the embodiment of the present invention.

Depending on whether the UE 100 is registered in the network, the state of the UE is roughly divided into RM_DEREGISTERED and RM_REGISTERED. RM (Registration Management)_DEREGISTERED indicates that the UE 100 is not registered in the network, and RM_REGISTERED indicates that the UE 100 is registered in the network.

Depending on whether a radio resource control (RRC) layer is connected between the UE 100 and a radio access network (RAN), the state of the UE is divided into RRC_IDLE and RRC_CONNECTED. RRC_IDLE indicates that the RCC layer is not connected and RRC_CONNECTED indicates that the RCC layer is connected.

When a signal connection between the UE 100 and the AMF 310 through an N1 interface (i.e. a NAS signal connection) is not connected and an AN (access network) signal connection, an N2 connection, and an N3 connection are not connected, the UE is in a CM (Connection Management) _IDLE state. Otherwise, the UE 100 is in a CM_CONNECTED state.

When the UE 100 is connected by performing a NAS message procedure such as a registration request or a service request in the CM_IDLE state, the UE 100 transitions from the CM_IDLE state to the CM_CONNECTED state.

When the UE 100 is connected to the AMF 310, the AMF 310 recognizes that the UE 100 is connected to a radio access network (RAN). At this time, the UE 100 belonging to access points (various BSs of FIG. 1) of the corresponding RAN may be in an RRC INACTIVE state and may not be performing RRC for connection management. When the UE 100 does not perform radio access and connection management for battery savings and an efficient use of radio resources in the CM_CONNECTED state, the UE 100 enters an RRC_INACTIVE CONNECTED state.

When an RRC Resume procedure for RRC connectivity recovery is performed between the UE 100 and the RAN, the UE 100 transitions from the RRC_INACTIVE CONNECTED state to the RRC_CONNECTED state. That is, the terminal may exist in a CM_CONNECTED/RRC_INACTIVE CONNECTED state and a CM_CONNECTED/RRC_CONNECTED state. The RRC resume procedure will be apparent to those skilled in the art and will not be described in detail.

Meanwhile, when the UE 100 releases from the network or releases the PDU Session, the UE 100 enters a CM_IDLE state.

The above-described state transition of FIG. 11 is described in 3GPP TS 23.501 and TS 23.502, and thus a more detailed description thereof will be omitted.

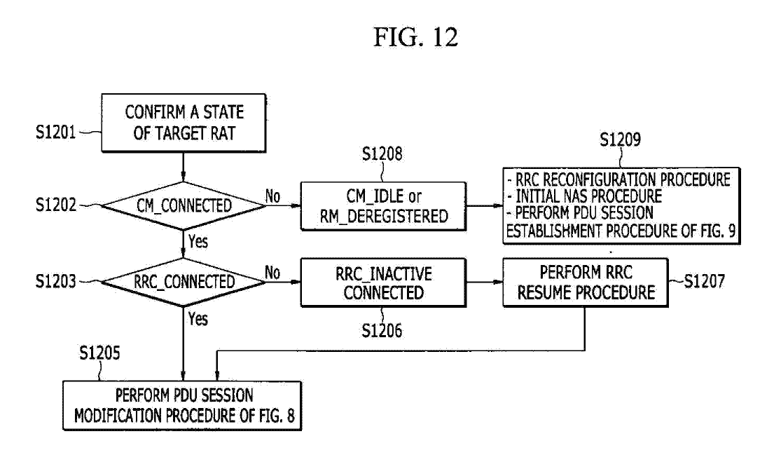

The UE 100 performing access traffic switching can manage a plurality of radio access networks (RANs) included in the UE 100 in a single state. In this case, the UE 100 can perform the access traffic switching through the procedure shown in FIGS. 6, 8, and 9. Meanwhile, when the UE 100 performs independent state management for each radio access network (RAN), the following procedure as shown in FIG. 12 is additionally performed, and then access network switching is performed. When the UE 100 attempts a traffic switch, a source RAT currently receiving service from the UE 100 is in an RRC_CONNECTED state and a CM_CONNECTED state. At this time, when the UE 100 switches the RAT to which traffic flow is being transmitted and received from a source RAT to a target RAT, the procedure differs depending on state of the target RAT. An access traffic switching method according to a state of the target RAT will be described with reference to FIG. 12.

FIG. 12 is a flowchart illustrating an access traffic switching method according to a state of a target RAT according to an exemplary embodiment of the present invention.

First, the UE 100 selects a traffic flow to be moved and a target RAT to be switched, and then confirms a state of the target RAT (S1201).

When the target RAT is in a CM_CONNECTED state and an RRC_ACTIVE state (S1202, S1203), the UE 100 performs a PDU Session Modification procedure of FIG. 8 (S1205). That is, if a state of the target RAT is a CM_CONNECTED state and an RRC_CONNECTED state, steps S810 to S890 of FIG. 8 are performed between the UE 100 and the network.

If a state of the target RAT is a CM_CONNECTED state and an RRC_INACTIVE state (S1202, S1203, S1206), the UE 100 performs the RRC resume procedure (S1207). That is, if a state of the target RAT is a CM_CONNECTED state and an RRC_INACTIVE_CONNECTED state, the RRC resume procedure is performed between the UE 100 and the base station of the target RAT. Through this RRC Resume procedure, the target RAT of the UE transitions from an RRC_INACTIVE_CONNECTED state to an RRC_CONNECTED state. After performing step S1207, the UE 100 performs step S1205 described above.

If a state of the target RAT is a CM_IDLE state or an RM_DEREGIEDED state (S1208), the UE 100 performs three procedures (S1209). First, an RRC reconfiguration procedure is performed between the UE 100 and the base station of the target RAT, and an RRC_CONNECTED state is established. Next, an initial NAS procedure (i.e., a Registration Request procedure or a Service Request procedure) is performed between the UE 100 and the AMF 310 to enter a CM_CONNECTED state. The RRC reconfiguration procedure and the initial NAS procedure will be apparent to those skilled in the art and will not be described in detail. Finally, the UE 100 performs the PDU Session Establishment procedure of FIG. 9. That is, the steps S910 to S991 of FIG. 9 are performed between the UE 100 and the network.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for user equipment (UE) to switch an access network in a heterogeneous access network, the method comprising,
receiving first data from a first network of multiple access networks,
selecting access network switching of the first data from a user,
selecting a second access network corresponding to the access network switching from the user,
performing access network switching to the second access network, and
receiving the first data from the second access network.

2. The method of claim 1, wherein the performing comprises determining whether the second access network is an access network that the UE is currently connected to.

3. The method of claim 2, wherein the performing further comprises transmitting a protocol data unit (PDU) session modification request message to an Access and Mobility Management Function (AMF) when the second access network is an access network to which the UE is currently connected in the determining.

4. The method of claim 3, wherein the PDU session modification request message comprises information on traffic of the first data and path information on the second access network.

5. The method of claim 4, wherein:
the performing further comprises receiving a PDU session modification response message from the AMF, and
the PDU session modification response message comprises an ACK for the PDU session modification request message.

6. The method of claim 2, wherein the performing further comprises establishing access to the second access network and transmitting a protocol data unit (PDU) session establishment request message to an Access and Mobility Management Function (AMF) when the second access network is not an access network to which the UE is currently connected in the determining.

7. The method of claim 6, wherein the PDU session establishment request message comprises a PDU session identifier that has been registered through the first access network, and a request type of the PDU session establishment request message comprises an existing PDU session or a multi-access PDU session and an added radio access technology type.

8. The method of claim 7, wherein:
the performing further comprises receiving a PDU session establishment response message from the AMF, and
the PDU session establishment response message comprises an ACK for the PDU session establishment request message.

9. The method of claim 1, wherein a unit of the first data is a data network, a tunnel for a data bearer, a service grouping a plurality of internet protocol (IP) flows, a QoS flow identity, or a single IP flow.

10. A method for switching a first access network, which is a current access network of a first data, to a second access network in a heterogeneous access network, the method comprising:
receiving, by user equipment (UE), the first data and the second access network from a user,
determining, by the UE, whether the second access network is an access network to which the UE is currently connected, and
requesting, by the UE, Access and Mobility Management Function (AMF) to switch an access network to the second access network.

11. The method of claim 10, wherein:
the requesting comprises transmitting a protocol data unit (PDU) session modification request message to the AMF when the second access network is an access network to which the UE is currently connected, and
the method further comprises confirming, by the AMF, a Session Management Function (SMF) corresponding to the PDU session modification request message, and transmitting, by the AMF, the PDU session modification request message to the SMF.

12. The method of claim 10, wherein:
the PDU session modification request message comprises information on an IP flow mobility (IFOM) rule update, and
the method further comprises transmitting, by the SMF, a PDU session modification response message to the AMF after the SMF updates the IFOM rule.

13. The method of claim 12, further comprising updating, by the UE, the IFOM rule after the UE receives the PDU session modification response message from the AMF.

14. The method of claim 10, wherein:
the requesting comprises transmitting a protocol data unit (PDU) session establishment request message to the AMF when the second access network is not an access network to which the UE is currently connected, and
the method further comprises selecting, by the AMF, a Session Management Function (SMF) corresponding to the PDU session establishment request message, and transmitting, by the AMF, the PDU session establishment request message to the SMF.

15. The method of claim 14, wherein:
the PDU session establishment request message comprises information on an IP flow mobility (IFOM) rule update, and
the method further comprises transmitting, by the SMF, a control message for path change to a User Plane Function (UPF) after the SMF updates the IFOM rule.

16. The method of claim 15, further comprising:
transmitting, by the UPF, a response message to the control message to the SMF,
wherein the response message comprises an ACK information for the updated IFOM rule.

17. The method of claim 11, wherein a unit of the first data is a data network, a tunnel for a data bearer, a service grouping a plurality of internet protocol (IP) flows, a QoS flow identity, or a single IP flow.

18. User equipment (UE) performing access network switching in a multiple access network, the UE comprising:
an radio frequency (RF) module receiving a first data flow from a first access network of the multiple access networks, and
a processor receiving access network switching of the first data flow from a user and selecting a second access network corresponding to the access network switching from the user,
wherein the processor determines whether the second access network is a network to which the UE is currently connected, and controls to request an Access and Mobility Management Function (AMF) to switch an access network to the second access network.

19. The method of claim 18, wherein:
the processor controls to transmit a protocol data unit (PDU) session modification request message to the AMF when the second access network is an access network to which the UE is currently connected, and
the PDU session modification request message comprises information on an IP flow mobility (IFOM) rule update.

20. The method of claim 18, wherein:
the processor controls to transmit a protocol data unit (PDU) session establishment request message to the AMF when the second access network is not an access network to which the UE is currently connected, and
the PDU session establishment request message comprises information on an IP flow mobility (IFOM) rule update.
